(19) United States
(12) Patent Application Publication
(10) Pub. No.: US 2004/0204985 A1
(43) Pub. Date: Oct. 14, 2004

(54) Digital image service and revenue generation

(76) Inventors: Donald P. Gibson, Yorba Linda, CA (US); Eric T. Jacobsen, Yorba Linda, CA (US); Jeffrey S. Myers, Newport Beach, CA (US); Yoshio Yamashita, Irvine, CA (US); Yoshifumi Ishikawa, Irvine, CA (US); Seiko Morita, Newport Coast, CA (US)

Correspondence Address: FITZPATRICK CELLA HARPER & SCINTO, 30 ROCKEFELLER PLAZA, NEW YORK, NY, 10112, US

(21) Appl. No.: 09/781,033

(22) Filed: Feb. 9, 2001

(51) Int. Cl. G06F 17/60

(52) U.S. Cl. 705/14; 348/221.1; 348/231.1

(57) ABSTRACT

The present invention comprises a system and method for providing image processing services and deriving revenue from such services as well as revenue from placement of advertising information passed on to users. A local image service center connected to a server computing system, offers services for uploading image data from a storage medium to local and/or remote storage as well as other services for processing uploaded image data. Access to uploaded image data is available via a cable television system. Revenue is derived from the services provided as well as from advertisers whose information is passed along to users.

### BACKGROUND OF THE INVENTION

1. Field of the Invention

The present invention relates to supplying services for uploading and processing image data such as that image data captured using digital image acquisition devices including still and video cameras as well as image data stored on removable storage media including, but not limited to, compact flash, smartMedia and memory stick, CD-ROM, DVD-ROM, ZIP disk and CLICK disk storage media. Image data may be retrieved locally using an image service that offers selectable services to process the image data and/or distribute the image data. Revenue is produced from the services selected by users as well as by revenue received from advertisers whose advertisements are passed on to the users.

2. Description of the Related Art

Digital cameras are becoming more popular, particularly as the quality of a captured image begins to approach the quality of analog cameras (e.g., 35 MM cameras). However, there are still some drawbacks with digital cameras. A digital camera has limited storage capacity which gives rise to a need to be able to transfer images captured by the digital camera to external storage.

Most digital cameras typically use some type of removable storage media, such as a CF (compact flash) card, smartMedia or memory stick storage media, to store captured images. However, the price for removable media can be quite high. For example, the price of a 128 megabyte (MB) compact flash card is approximately $350.00, and the price of a 64 MB compact flash card is approximately 108.00. A purchaser is not likely to want to purchase the removable media unless it can be seen that its level of use can justify the cost of the media.

The storage capacity needed typically depends on the amount of image data needed to be stored before being able to offload the data to external storage. Thus, a digital camera user may minimize the amount of removable media needed by uploading captured images to external storage media (e.g., a hard drive) periodically rather than purchasing additional removable media.

Typically, a digital camera user retrieves image data saved in the camera's storage (e.g., the removable media) using a personal computer, or PC. There are times, however, when a digital camera user may not have access to a PC or other mechanism for uploading captured images. For example, while on vacation, a digital camera user may not have the ability to store the image data to a PC or other external storage. In such a case, it may be necessary to purchase additional removable media that the user would not otherwise need.

Recently, photo kiosks have been designed for placement in various locations (e.g., retail stores, airports, hotels, etc.) for receiving image data. A photo kiosk is typically a booth, or some type of structure that houses the hardware (e.g., display, computing system, etc.) needed to carry out the local functions of the kiosk. A photo kiosk typically includes a type of computer processing system with a display and may include other devices such as a scanner, removable media reader, printer, CD-ROM drive, modem and the like. In addition, the photo kiosk includes the software needed to configure the computer system to provide functionality local to the kiosk.

In a case that the kiosk has a computer system that is to be used to retrieve image data, the system includes software to allow a user to retrieve image data for transfer to external storage. In addition, a photo kiosk may offer the ability to generate hardcopy prints of the image data, retouch an image, and upload the image to the Internet. Where the hardcopy prints are generated at the photo kiosk, the kiosk includes a printer of some kind to generate the hardcopy output.

The more capability that is provided by the kiosk, the greater the manufacturing costs. In order to provide incentive for a manufacturer to manufacture a kiosk, the manufacturer should recoup the manufacturing costs involved as well as make a profit.

Like the manufacturer, there should be some incentive for a site such as a retail store or a hotel to provide space for a photo kiosk. Incentive may be provided in the form of monetary gains and/or goodwill, for example If the incentive is primarily to increase goodwill with a patron by offering the services provided by the photo kiosk, it is beneficial to be able to offset the cost of the kiosk services offered to a user in some manner.

Thus, it would be beneficial to be able to provide a method of producing revenue for each of the parties involved in providing the kiosk and the services provided by the kiosk. In addition, it would be beneficial to be able to produce additional revenue in the form of revenue subsidies that may be used, for example, to offset the cost of the kiosk or to supplement the revenue generated from services provided via the kiosk.

### SUMMARY OF THE INVENTION

The present invention comprises a system and method for providing image processing services and deriving revenue from such services as well as revenue from placement of advertising information passed on to users. A local image service center, or kiosk, which includes a receiving station (or terminal) connected to a server computing system, offers services for uploading image data from a storage medium to local and/or remote storage as well as other services for processing uploaded image data. In a case that the local image service center is interconnected with a cable television network, the present invention may be used to access uploaded image data and perform image processing operations via the cable television network. Revenue is derived from the services provided as well as from advertisers whose information is passed along to users.

The revenue that is derived from the services and the advertisements may be distributed among the various entities such as those that provide the kiosk, the space for the kiosk and/or those that provide the services that are accessible by virtue of the kiosk.

According to the present invention, revenue may be generated for image data processing services (e.g., generating hardcopy or storage copies of the image data stored on removable storage media such as CD-ROM, DVD-ROM and Iomega's ZIP and CLICK disk storage media) as well as from an advertiser whose advertisements are distributed to kiosk users via the present invention. Generated revenue may be distributed using any number of distribution schemes to the kiosk host (e.g., a hotel, shopping mall, etc.), the kiosk manufacturer and/or a photo services provider. The revenue generated from advertisement may be used to supplement the cost of some or all of the image data processing services.

According to an aspect of the invention, a system configured to provide digital image services and generate revenue therefrom may include storage for advertising information and retrieved image data. A receiving station provides an interface with a device that is able to retrieve image data from removable storage media such as that used in a digital image acquisition device (e.g., a still or video camera or a scanning device). A server receives the image data from the receiving station and stores the data in the image storage. In addition, the server receives and stores advertising information.

In response to an output request, the server outputs the advertising information with the image data. For example, the server may generate a postcard that includes a photo taken in front of a restaurant as well as an advertisement that includes a picture of the restaurant. In addition, the server may output image data for storage to persistent removable storage media. Additional services include, but are not limited to, transferring image data to recipients or locations (e.g., photo sharing web site) designated by the user. The image data transfer may be performed via electronic mail transfer or via a file transfer operation.

This brief summary has been provided so that the nature of the invention may be understood quickly. A more complete understanding of the invention can be obtained by reference to the following detailed description of the preferred embodiment(s) thereof in connection with the attached drawings.

### BRIEF DESCRIPTION OF THE DRAWINGS

FIG. 1 is an outward view of computing hardware used in providing digital image services and generating revenue according to the present invention.

FIG. 2 is a block diagram of the internal architecture of a computer system according to the present invention.

FIG. 3 provides an example of revenue generation and distribution according to the present invention.

FIG. 4 illustrates a regional broadband digital cable network that is used to provide digital image services and generate revenue according to the present invention.

FIG. 5 illustrates representative software architecture of a set top box according to the present invention.

FIG. 6 provides an overview of an architecture for use in transferring digital image data and associated information between a cable head end and a set to box according to the present invention.

FIG. 7 is a user interface that may be displayed on television 11 for ordering digital image data services and presenting advertising information according to the present invention.

FIGS. 8A and 8B illustrate flow diagrams of process steps to provide image services and generate revenue according to the present invention.

### DETAILED DESCRIPTION OF THE PREFERRED EMBODIMENTS

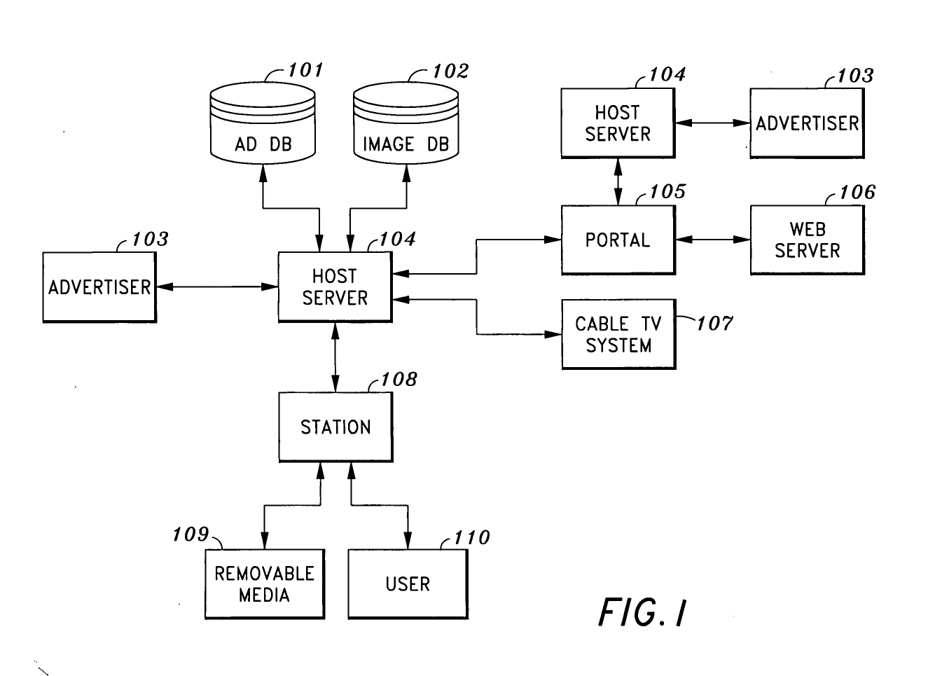

FIG. 1 is an outward view of computing hardware used in providing digital image services and generating revenue according to the present invention.

Server 104 is a computer system that is configured to receive advertising information from advertiser 103 and to cause the advertising information to be stored in advertising database 101. In addition, server 104 receives, via station 108, image data as well as information associated with a user 110 and causes the image data and user data to be stored in image database 102.

Station 108 is a computing system that is configured to interact with user 110 to retrieve and/or process images stored on removable media 109. Station 108 may be a photo kiosk, for example, or other image service center device with computing capability and an ability to interface with user 110. Station 108 interfaces with removable media 109 so as to cause information stored on removable media 109 to be retrieved and/or to store information on removable media 109. Examples of removable media 109 include, but are not limited to, compact flash, smartMedia, memory stick, CD-ROM, DVD-ROM, Iomega's ZIP and CLICK disks, smart card, etc.

Server 104 interacts with portal 105 and may access web server 106 via portal 105. As is described in more detail below, server 104 interacts with cable television (or CATV) system 107 to allow user 110 to perform various operations involving image data uploaded via station 108 to image database 102.

Server 104 may be hosted by a business such as a hotel, retail store, public attraction, restaurant, movie theater, etc., and advertiser 103 is an entity whose goods and/or services would be of interest to user 110, such as a business that is local to the host business. Examples of advertiser 103 include, but are not limited to, a restaurant, store, tourist attraction, movie theater, hotel, etc.

In one revenue generation approach described in more detail below, portal 105 is supplied by the same entity that supplies station 108 and storage media (e.g., removable storage media such as a readable or read/writable CD-ROM and DVD-ROM or Iomega's ZIP or CLICK disks, compact flash, smartMedia, etc.) for storing copies of the uploaded image data. However, it should be apparent that the goods and/or services described herein as being provided by a single entity may be provided by more than one entity. In such a case, revenue generated according to the present invention may be divided among the different entities.

Advertising information is gathered from advertiser 103 by server 104. As is shown in FIG. 1, more than one server 104 may be connected to portal 105. Thus, it is possible that server 104 may include advertising information uploaded directly to server 104 by advertiser 103 as well as advertising information uploaded to another instance of server 104 and forwarded (via portal 105) to the first instance of server 104. Advertiser 103 may elect to run a local advertising campaign using a local server 104, or expand its advertising to multiple locations and instances of server 104. An instance of server 104 may therefore store, in advertising database 101, local advertising information geared for a local audience as well as advertising information for a more diverse, or widespread audience. Thus, server 104 can receive advertising information that is unique to server 104 as well as advertising information that is shared between instances of server 104.

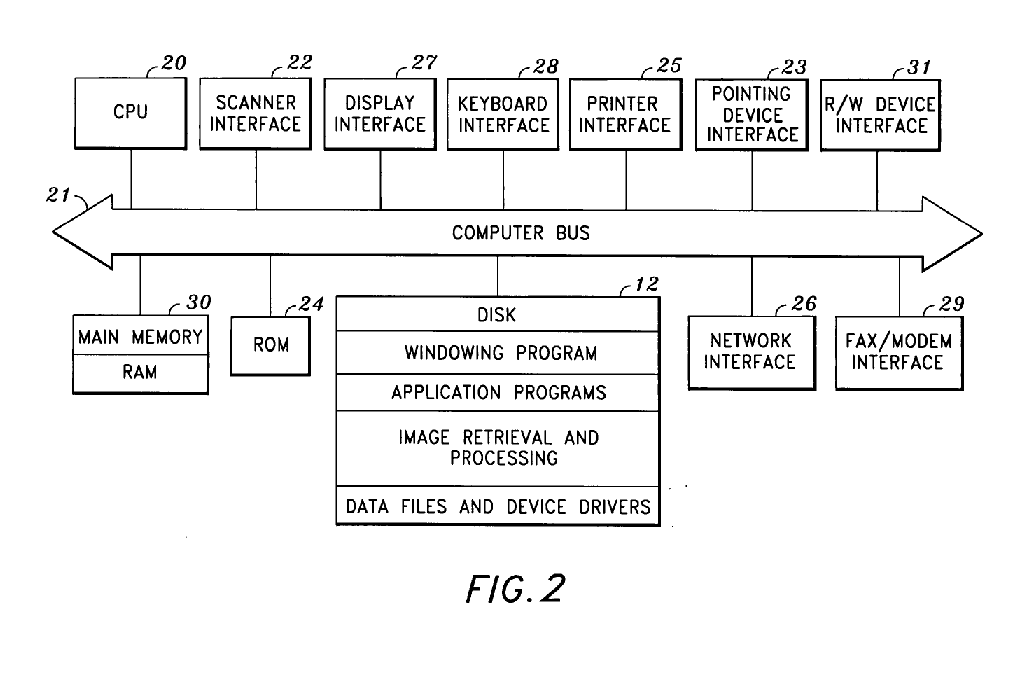

FIG. 2 is a block diagram of an internal architecture of a computer system, such as station 108, server 104, portal 105 or web server 106, according to the present invention. Shown in FIG. 2 are CPU 20, which is preferably a Pentium-type microprocessor, interfaced to computer bus 21. Also interfaced to computer bus 21 are printer interface 25, to allow station 108 to communicate with a printer, modem interface 29 to enable communications between station 108 and a modem, network interface 26 to enable communication with a network (e.g., a local area network, intranet, etc.), display interface 27 for interfacing with a display monitor, keyboard interface 28 for interfacing with a keyboard, and pointing device interface 23 for interfacing with a pointing device (e.g., a mouse). Scanner interface 22 provides an interface to a scanning device, and read/write device interface allows the computer system to communicate with devices configured to read from and write to removable storage media.

Read only memory (ROM) 24 stores invariant computer-executable process steps for basic system functions such as basic I/O, start up, or reception of keystrokes from keyboard.

Main random access memory (RAM) 30 provides CPU 20 with memory storage which can be accessed quickly. In this regard, computer-executable process steps are transferred from disk 12 over computer bus 21 to RAM 30 and executed therefrom by CPU 20.

Also shown in FIG. 2 is disk 12 which, as described above, preferably includes a windowing operating system, a web browser executable on the particular windowing operating system. Other applications may include graphics and electronic mail applications, for example, as well as image retrieval and editing applications. Disk 12 further includes data files and device drivers as shown.

Server 104, portal 107 and web server 106 have a similar internal architecture to that of station 108. Preferably, server 104 and portal 107 are interconnected via the internet.

To facilitate communication with the internet, server 104, portal 107 and web server 106 may further include a TCP/IP layer wherein the TCP portion of a packet received via the internet is removed and an HTTP or, in a case of a secure (e.g., encrypted) packet, an HTTPS packet is forwarded to HTTP, or HTTPS, server software, respectively. The HTTP (or HTTPS) server software may forward the request to an application so that the application may respond to the request, the response being forwarded to the requester via the HTTP, or HTTPS, Server, the TCP/IP Layer and the internet.

The present invention comprises a system and method for providing image processing services and deriving revenue from such services as well as revenue from placement of advertising information passed on to users. Revenue may be generated from goods and services rendered according to the present invention.

Image processing services including image data upload, storage, forwarding, and output to print and persistent removable media storage, for example are provided using computing hardware such as that described above.

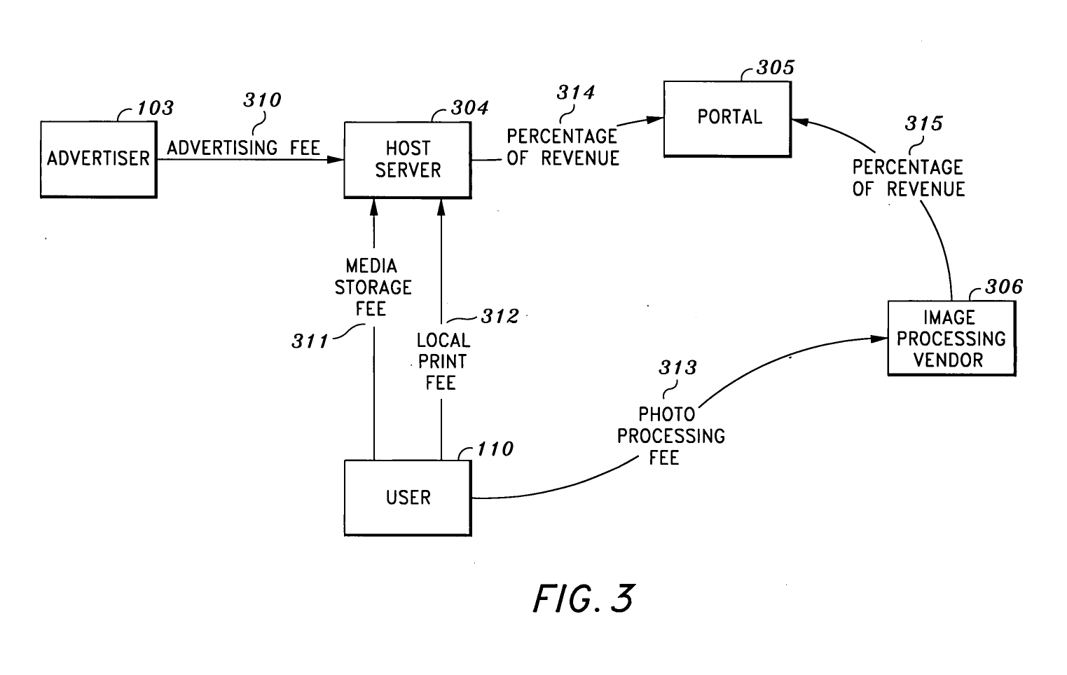

The revenue that is derived from the services and the advertisements may be distributed among various entities. Revenue may be derived from image processing services and output supplied to user 110 as well as advertising services rendered to advertiser 103. FIG. 3 provides an example of revenue generation and distribution according to the present invention.

Advertising fee 310 is paid by advertiser 103 to host 304. The manner of calculating advertising fee 310 may vary. For example, advertising fee 310 may be based on an actual, or potential, number of users 110 to receive the advertising information of advertiser 103. Alternatively, advertising fee 310 may be based on a number of advertisements provided to host 304 by advertiser 103. A different calculation of advertising fee 310 may be applied by host 304 to different advertisers 103. In addition, advertising fee 310 may depend on whether the advertising information is distributed to a single instance of host 304 or to multiple instances of host 304.

According to the present invention, revenue may be generated for image data processing services (e.g., generating copies such as a print copy or a persistent storage copy on media such as CD-ROM, DVD-ROM and Iomega's ZIP disks) provided to user 110.

Media storage fee 311 is paid by user 110 to host 304 in a case, for example, that host 304 supplies, or causes to be supplied, to user 110 a copy of image data stored on persistent storage media. In addition, user 110 may pay a local print fee 312 to host 304, in a case that host 304 generates, or causes to be generated, print output of image data. User 110 pays a photo processing fee 313 for photographs, or other print output, to image processing vendor.

Revenue generated from advertising fee 310, media storage fee 311, local print fee 312 and/or image processing fee 313 may be distributed to the various entities such as host 304 and portal 305 to generate profit and offset the costs involved in supplying the hardware and services.

It is further possible to use revenue generated to provide one or more services free of charge. For example, it is possible to offer free uploading of image data by user 110 to server 104 via station 108.

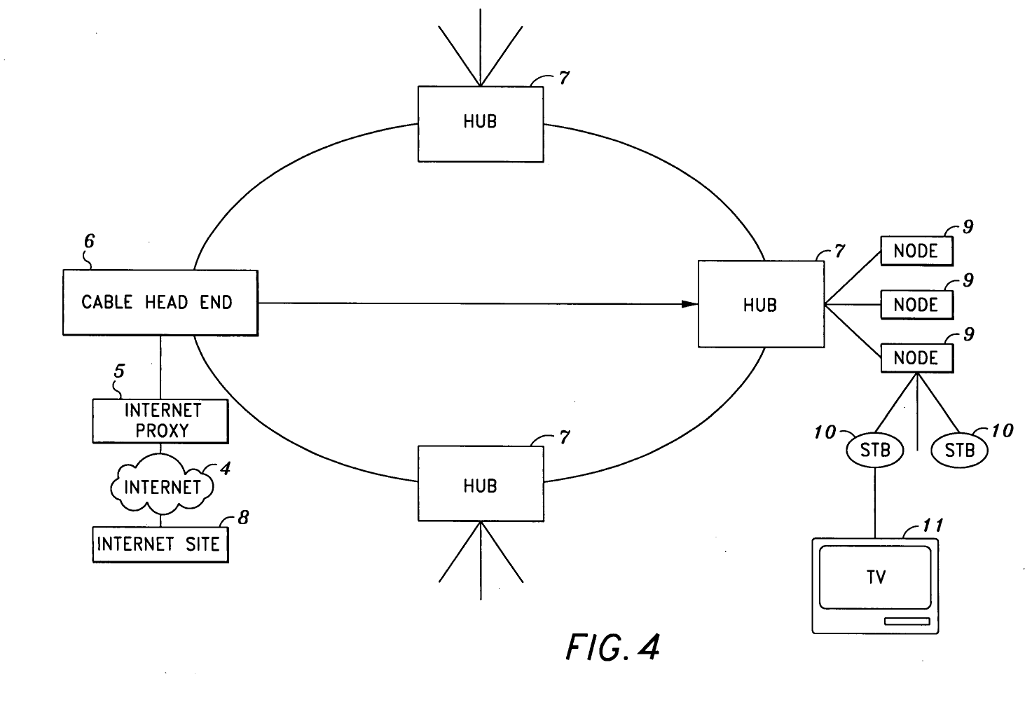

In addition to station 108, image data retrieved using station 108 and stored in image database 102 may be accessed, according to the present invention, from CATV system 107. CATV system 107 may be a broadband digital cable network such as that illustrated in FIG. 4.

As depicted in FIG. 4, the broadband digital cable network may be connected to the internet (or World Wide Web, WWW) 4. The digital cable network is capable of delivering analog and digital broadcasts, secure analog and digital broadcasts, analog and digital pay-per-view, analog and digital impulse pay-per-view, digital near video on demand, one-way real-time datagram (broadcast IP data packets), and two-way real-time datagram (addressed IP data packets). In addition, according to the present invention, the regional broadband digital cable network is used to transmit digital image data and associated information.

The above-listed broadcast services may be delivered by value-added service provider systems and network control systems (not shown) located at cable head end (CHE) 6. Value-added service provider systems include digital satellite distribution systems, applications executing on cable servers (such as special-purpose applications like subscriber service application, content gather applications, etc.) and digital media servers outputting MPEG-2 datastreams. Network control systems provide management and control for the services supported by the broadband network.

Alternatively, services may be delivered from internet 4 through internet proxy 5, for example, from internet site 8. Examples of internet site 8 include photo service providers, banking, retailing, utilities, and the like.

In either case, the services are delivered to Cable Head End (CHE) 6, which serves as an interface between the service providers and the rest of the broadband network.

In particular, CHE 6, which is responsible for providing services to multiple nodes 9 (e.g., approximately 500,000 to 1,000,000), is connected via fiber optic cabling to hubs 7, which are connected to CHE 6 or other hubs 7. Each hub 7 is, in turn, connected to at least one node 9, also using fiber optic cabling. Coaxial cable is then used to connect each node to Set Top Boxes (STB's) 10. For instance, the STB 10 may be one of several currently available STB models available such as Scientific Atlanta's Explorer series and General Instrument's DCT-2000 and DCT-5000+ models. While the present invention is described with regard to a STB, it should be apparent that any type of home interface control (HIC) that interfaces with a broadband network such as a digital cable network may be used. Finally, each STB 10 is connected to television 11 and may be connected to other devices not shown (e.g., printer, scanner, etc.). Accordingly, services are delivered from a service provider to CHE 6, to one or more hubs 7, to node 9, to STB 10 and to television 11.

It should be noted that, by virtue of the foregoing arrangement, a service infrastructure may be distributed among CHE 6, hubs 7, or other facilities. Further, while the present invention is described with reference to a digital cable network of FIG. 4, it should be apparent that any broadband network interconnection may also be used between a client such as STB 10 and a server such as CHE 6. For example, it is possible to use a satellite, or other connection, with the present invention. CHE 6 may be a separate, or the same, computer system as server 104.

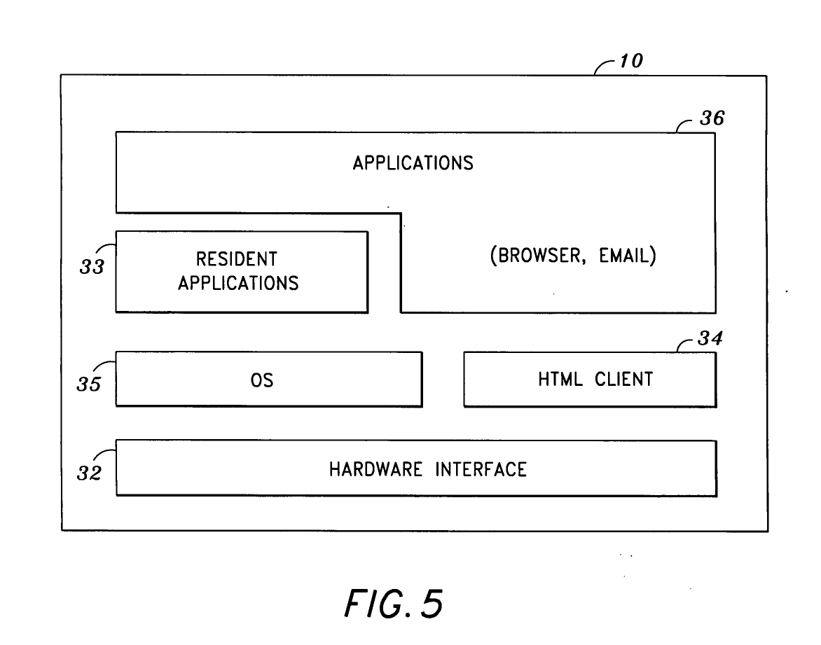

FIG. 5 illustrates representative software architecture of a set top box (e.g., set top box 10) according to the present invention. In general, this software architecture, together with the hardware architecture of the set top box, supports, in addition to the reception of analog and digital services, the transmission of digital image data and associated information.

Through the software architecture illustrated in FIG. 5, STB 10 hosts various applications that present to the home user functionality offered by various cable services. Typical applications are a navigator, an interactive program guide, electronic mail and a web browser. Most of these applications are client/server implementations, where STB 10 hosts the client software, and CHE 6 hosts the server software. Communication between client and server over the cable network is facilitated by an operating system executed on STB 10, and is performed through API's. One example of an API that may be used to communicate between CHE 6 and STB 10 is a broadband protocol transport (BPT) which is offered by Canon Information Systems, Inc. of Irvine, Calif. However, it should be apparent that any protocol suitable for use over a broadband network may be used with the present invention As is described herein, CHE 6 and STB 10 may communicate using the Hypertext Transfer Protocol (HTTP). Depending on the hardware platform and the operating system, applications may be resident at STB 10, or can be downloaded from a remote site including servers situated at, or available via, CHE 6 for execution at STB 10.

As shown in FIG. 5, software architecture and STB 10 includes an interface 32 to hardware, an operating system 35, an HTML client 34, resident applications 33, and other applications 36. As is described in more detail below, resident applications 33 includes a resident device module that operates to cause a loadable device module to be loaded. The loadable device module is configured to communicate with CHE 6 to transfer digital image data and associated information between STB 10 and CHE 6.

The operating system 35 is usually vendor-specific for the STB, and may include operating systems such as PowerTV, WinCE, MicroWare or OpenTV. HTML client 34 provides a group of independent handlers that can be plugged together in conformity to known plug-in specifications so as to provide ability to handle different types of media such as HTML, GIF, MPEG, HTTP, Java script, etc. The HTML client 34 is used to allow STB 10 to render HTML documents to a windows manager for display on the local television receiver. HTML documents may be retrieved from local cache, from in-band and out-of-band broadcast carrousels, VBI streams, HTTP proxy servers located at CHE 6, or remote HTTP servers accessed by STB 10 over the internet. In the latter case, documents retrieved from external web servers are filtered by a proxy according to predefined filtering criteria (such as surf watch), which also may convert requested documents into formats supported by the HTML client 34.

Resident applications 33 include such applications as the aforementioned resident device module, navigator, interactive program guide, and the like. Applications 33 and 36 include a web browser, an e-mail program, loadable device module, and the like.

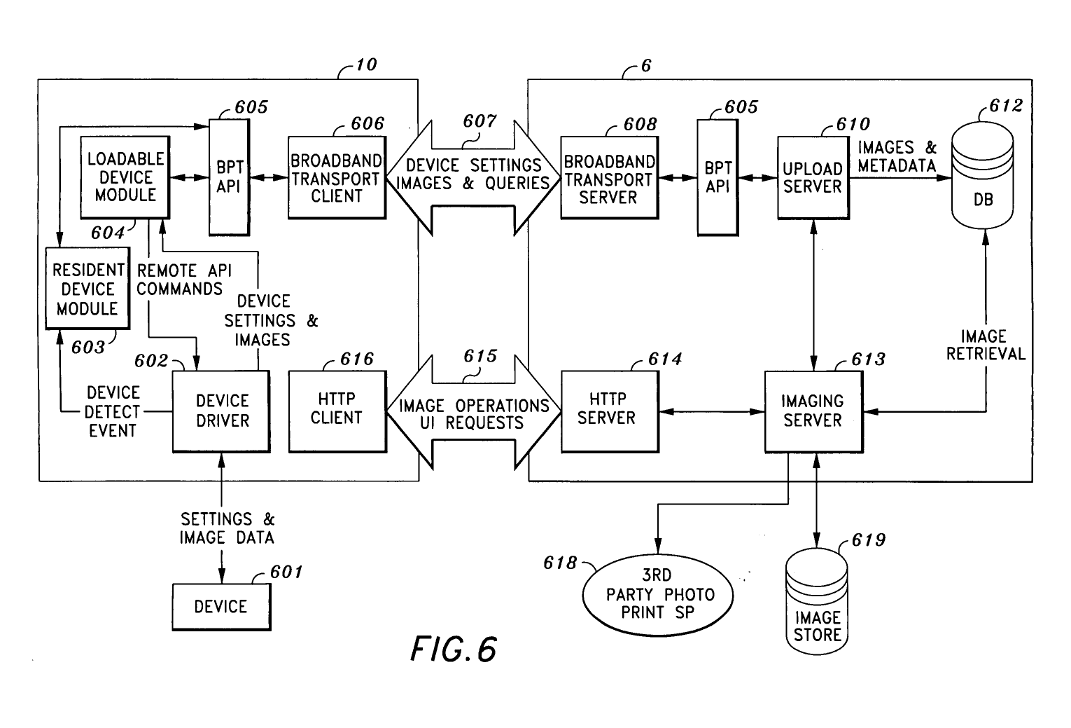

FIG. 6 provides an overview of an architecture for use in transferring digital image data and associated information between a cable head end and a set to box according to the present invention.

As part of hardware interface 32, device driver 602 provides an interface to device 601 external to STB 10 and connected via an interface to STB 10. Examples of such an interface include a Universal Serial Bus (USB), parallel and a IEEE 1394 interface connection. Device 601 is, for example, a digital device such as a still or video camera or a scanning device. Alternatively, device 601 may be a device (e.g., a reader) that is capable of retrieving data stored on a removable storage media such as a compact flash card, smartMedia or memory stick media, for example. Thus, device 601 is a digital image storage device that may or may not additionally be able to acquire, or capture, digital image data. Device driver 602 is configured to send and receive messages to and from device 601.

Device driver 602 detects device 601 when it is plugged into an external interface of STB 10. Information received by device driver 602 from device 601 is forwarded to resident device module 603. Such information includes type, or identification, information such as manufacturer and product identification information, and may also include information associated with user 110 (e.g., name, password, etc.).

Resident device module 603 identifies an appropriate loadable device module 604 for use in communicating with device 601 and CHE 6 to transfer image data and associated information. Where the identified loadable device module 604 is not available on STB 10, resident device module 603 causes loadable device module 604 to be transferred to STB 10 and initiated on STB 10. Loadable device module 604 may be transferred from a location that is accessible to STB 10.

Loadable device module 604 communicates with upload server via a broadband protocol transport (BPT) application programming interface (API) 605 that interfaces with broadband transport client 606 and broadband transport server 608 components executing on STB 10 and CHE 6, respectively. Communication channel 607 is formed over broadband digital cable network and is used to transmit such information as device settings, images and queries, for example. In addition to transmitting image data and associated information, communication channel 607 may be used to request and receive loadable device module 604.

Image data received by upload server 610 is stored in database (or data store) 612. Requests for stored image data may be received by imaging server 613. For example, HTTP client 616 executing on STB 10 may forward a request (e.g., an Hypertext Markup Language, or HTML, request), via communication channel 615, for one or more images via HTTP server 614 to imaging server 613. In addition, imaging server 613 may receive an image request from such internet sites as photo print service provider 618. Where imaging server 613 is server 104, database 612 corresponds to image database 102 and image data stored therein is retrieved in response to such request. Where imaging server 613 is not server 104, imaging server 613 forwards a request to server 104 for the stored image data. Server 104 retrieves the requested image data from image database 102 and forwards the retrieved image data to imaging server 613.

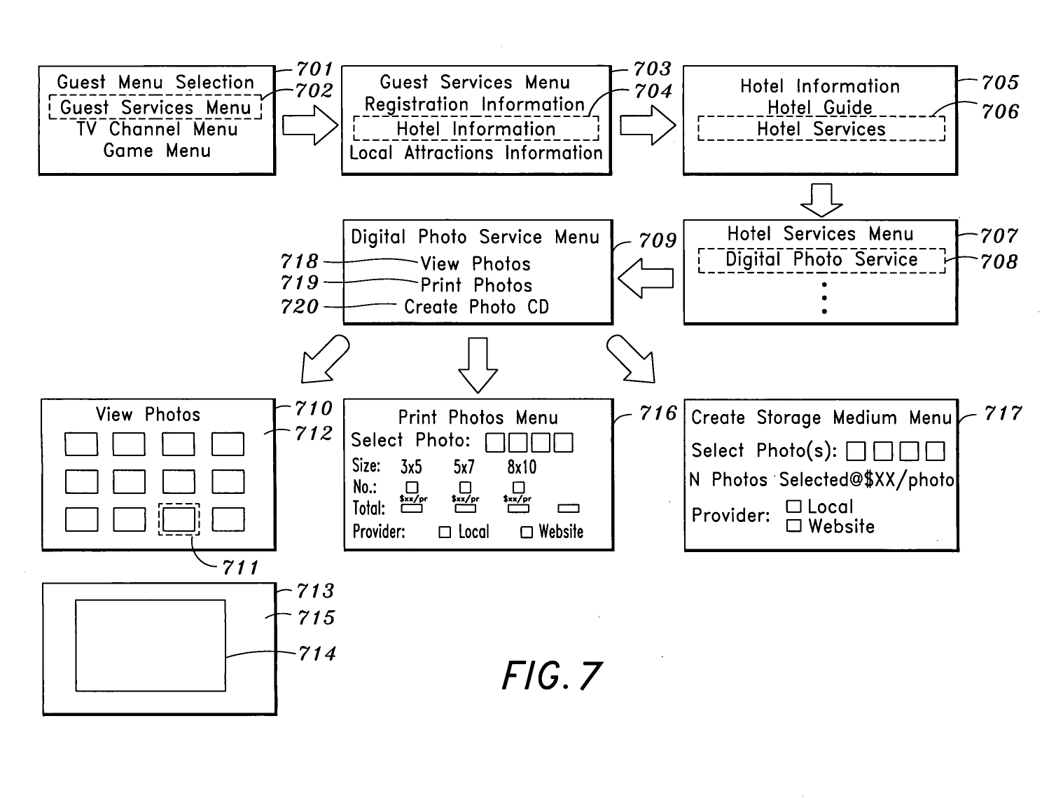

FIG. 7 provides examples of displays of a user interface that is displayed on television 11 for manipulating image data according to the present invention. In a series of displays, the user can navigate to a display with options for viewing, printing and storing image data.

Display 701 is a guest menu display that allows the user to choose between guest services, television channel selection and game menu options. In a case that the user selects the guest services option 702, display 703 containing a guest services menu is displayed on television 11. Display 703 includes registration information, hotel information and local attractions information options. Responsive to selection of a hotel information selection 704, display 705, which includes hotel guide and hotel services options, is displayed. In a case that a hotel services option 706 is selected, display 707 is displayed in response. In display 707, the hotel services menu includes a digital photo service option 708 which when selected causes display 709 to be displayed.

In a case that a view photos option 718 is selected in display 709, display 710 is provided which includes thumbnail images corresponding to image data stored in image database 102. Advertising information may be displayed in display 710. For example, advertising information may be displayed in border area 712 surrounding the thumbnail images.

User 110 may select a thumbnail image 711 in display 710 to cause an image corresponding to thumbnail image 711 to be displayed in display 713. Advertising information may be displayed in display 713 such as in border area 715 surrounding image 714 in display 713.

Returning to display 709, in a case that user 110 chooses the print photos selection 719, display 716 is displayed on the screen of television 11. Display 716 includes a section for displaying thumbnail images that correspond to stored image data. While not shown in display 709, a scrolling capability may be used to allow user 110 to scroll through additional rows (or columns) of thumbnail images. In addition to selecting image data, user 110 specifies a size (or sizes) and number of photographs in each of the selected sizes.

A total amount of the processing fees associated with each size photograph ordered based on a price per print is displayed along with an aggregate total. This amount may be charged to user 110 or an account of user 110, for example. In addition, user 110 may specify that the print output is to be generated locally (e.g., a printer made locally available by host 304), or at a remote location (e.g., web server 106 or image processing vendor 306).

When user 110 selects the create photo CD option 720 in display 716, display 717 is displayed on television 11. Display 717 allows user 110 to select photos, as in display 716, and indicate the provider (or location) that is to generate the persistent storage medium containing the selected photos.

In addition to displays 710 and 712, any and all of the displays of FIG. 7 may include advertising information. A similar user interface may also be presented at station 108 which includes a displays 709, 710, 716 and 717 thereby allowing user 110 to view, print and copy image data from station 108.

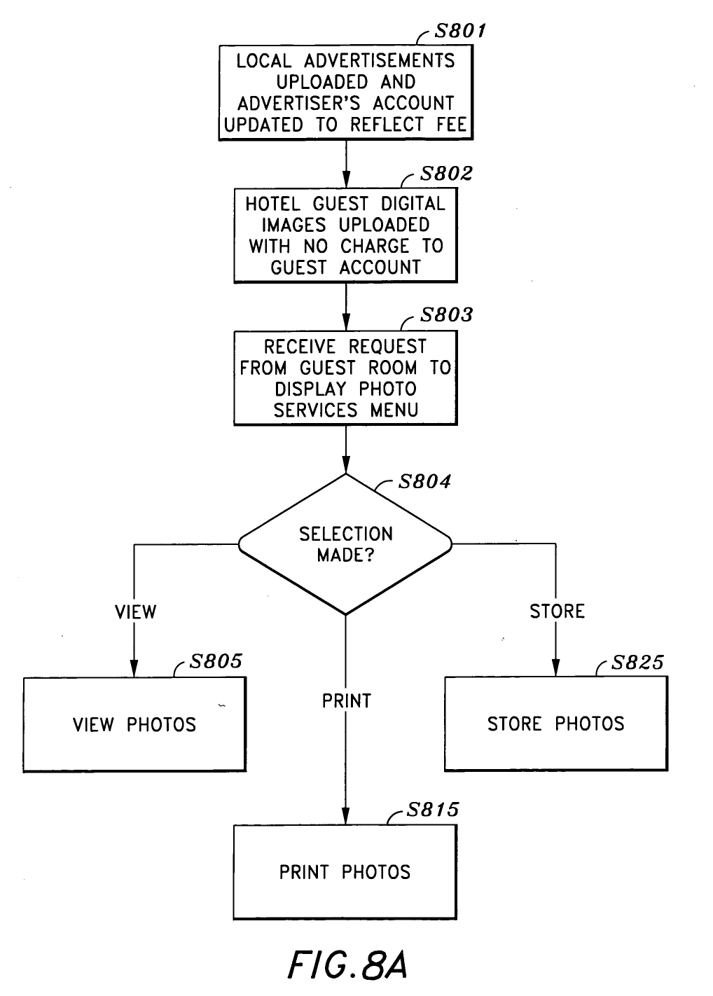

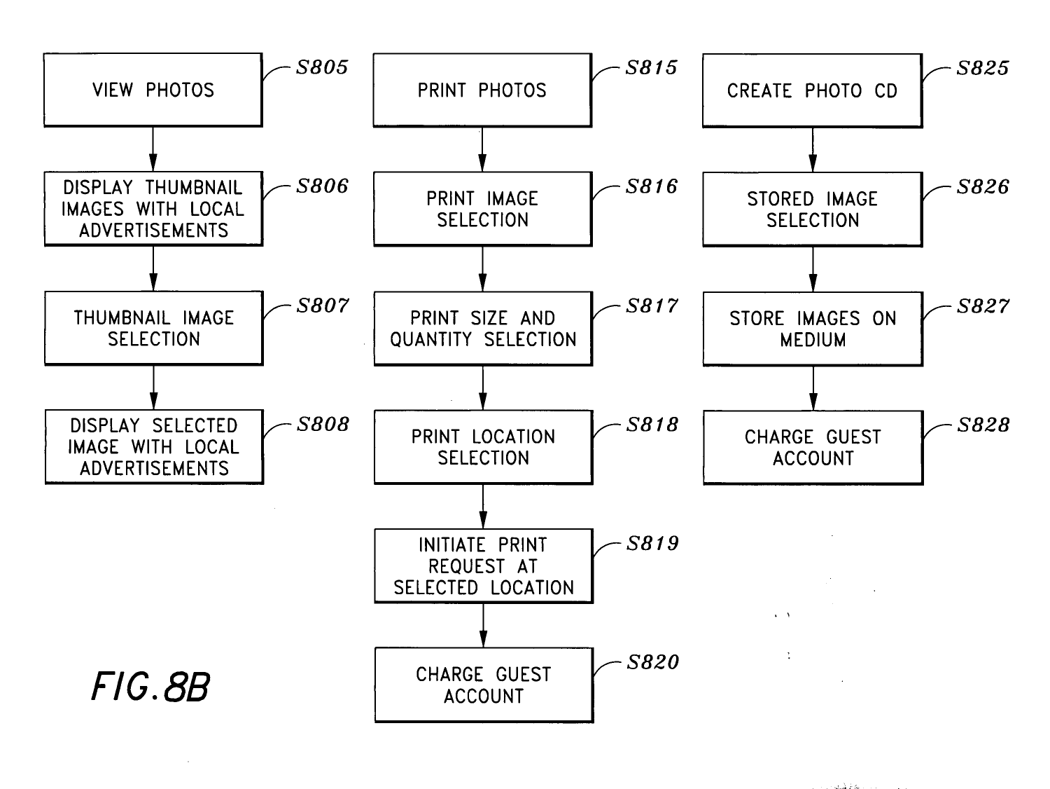

FIGS. 8A and 8B illustrate flow diagrams of process steps to provide image services and generate revenue according to the present invention.

At step S801, advertiser 103 uploads advertising information to server 104, and an account associated with advertiser 103 is updated to reflect any fees for such upload. At step S802, user 110 (e.g., a hotel guest) uploads digital images (at no charge to user 110) using either station 108, or CATV system 107 as described above. At step S803, CATV system 107 receives a request to display a photo services menu (e.g., display 709 of FIG. 7).

At step S804, it is determined whether a selection is made and which option (e.g., options 718 through 719) presented in the displayed photo services menu is selected. If it is determined that a view option (e.g., option 718 of display 709) is selected, processing continues at step S805. If it is determined that a print option (e.g., option 719 of display 709) is selected, processing continues at step S815. Alternatively, if it is determined that a store option (e.g., option 720) is selected, processing continues at step S825.

Referring to FIG. 8B, in a case that user 110 selects the view photos option 718, display 719 is presented at step S806 to display thumbnail images that correspond to stored image data (e.g., image data uploaded by user 110 in step S802 of FIG. 8A). At step S807, a thumbnail image is selected by user 110. In response, image data corresponding to the selected thumbnail image is displayed (e.g., as in display 713) along with advertising information such as that uploaded by advertiser 103 in step S801 of FIG. 8A.

In a case that user 110 selects the print option 719, display 716 is presented. At step S816, a thumbnail image corresponding to uploaded image data is selected. At step S817, a print size and quantity is selected, and a print location, or provider, is selected at step S818. At step S819, a print requested is initiated at the request location. And at step S820, an account of user 110 is charged a fee for printing the image data.

If it is determined, at step S804 of FIG. 8A, that a create medium selection is made with stored image data, a display (e.g., display 717) is presented to user 110 to select the image data to be copied to the storage medium (e.g., a CD-ROM, etc.). At step S825 of FIG. 8A, user 110 selects the thumbnail image(s) corresponding to the stored image data. At step S827, the storage medium is generated with the selected image data. At step S828, an account of user 110 is charged a fee for creating the image data copy on the storage medium.

In this regard, the invention has been described with respect to particular illustrative embodiments. However, it is to be understood that the invention is not limited to the above-described embodiments and that various changes and modifications may be made by those of ordinary skill in the art without departing from the spirit and the scope of the invention.

What is claimed is:

1. A method of providing digital image services and generating revenue therefrom, the method comprising:
receiving, at a first location, image data retrieved from removable storage media and storing the image data at the first location;
receiving and storing advertising information at the first location, at least some portion of the advertising information is unique to the first location; and
responsive to an output request, generating output of the image data, the output including the advertising information,
wherein revenue is generated from the use of the advertising information.

2. A method according to claim 1, further comprising:
responsive to a request at the first location, uploading the image data from the first location to a second, remote location.

3. A method according to claim 1, wherein the output is hardcopy output.

4. A method according to claim 3, wherein other revenue is generated from purchase of the hardcopy output.

5. A method according to claim 3, wherein the hardcopy output is a postcard.

6. A method according to claim 3, wherein the hardcopy output is a photograph.

7. A method according to claim 1, wherein the output is saved to a removable storage medium.

8. A method according to claim 7, wherein the removable storage medium is a CD-ROM, DVD-ROM, ZIP disk or a CLICK disk.

9. A method according to claim 1, wherein revenue is generated from purchase of the hardcopy output.

10. A method according to claim 1, wherein the output is a display.

11. A method according to claim 1, wherein the display includes a display of the image data and the advertising information.

12. A method according to claim 1, wherein the display includes a display of the image data.

13. A method according to claim 12, wherein the displayed image data is a thumbnail image of the image data.

14. A method according to claim 1, wherein the output request is generated through a cable television system.

15. A system configured to provide digital image services and generate revenue therefrom, comprising:
advertising data store accessible locally for storing advertising information;
image data store accessible locally for storing image data uploaded from removable storage media;
receiving station capable of interfacing with a device to retrieve the image data from the removable storage media; and
server configured to save image data received from the receiving station to the image data store and to save received advertising information to the advertising data store, and to respond to a request to output the image data the server outputting the advertising information with the image data,
wherein revenue is generated from the advertising information.

16. A digital image services system according to claim 15, wherein the server is configured to upload the image data to a remote server.

17. A system according to claim 16, wherein the remote server provides image data processing services, other revenue is generated from the purchase of at least one of the services.

18. A system according to claim 15, further comprising:
a set-top box connected to the server, the set-top box configured to display a user interface comprising image processing selections and image data.

19. A computer-readable memory medium in which computer-executable process steps are stored, the process steps for providing digital image services and generating revenue therefrom, wherein the process steps comprise:
a first receiving step to receive, at a first location, image data retrieved from removable storage media and storing the image data at the first location;
a second receiving step to receive advertising information and store the advertising information at the first location, at least some portion of the advertising information is unique to the first location; and
a generating step responsive to an output request, to generate output of the image data, the output including the advertising information,
wherein revenue is generated from the use of the advertising information.

20. Computer-readable memory medium according to claim 19, further comprising:
an uploading step, responsive to a request at the first location, to upload the image data from the first location to a second, remote location.

21. Computer-readable memory medium according to claim 19, wherein the output is hardcopy output.

22. Computer-readable memory medium according to claim 21, wherein other revenue is generated from purchase of the hardcopy output.

23. Computer-readable memory medium according to claim 21, wherein the hardcopy output is a postcard.

24. Computer-readable memory medium according to claim 21, wherein the hardcopy output is a photograph.

25. Computer-readable memory medium according to claim 19, wherein the output is saved to removable storage medium.

26. Computer-readable memory medium according to claim 25, wherein the removable storage medium is a CD-ROM, DVD-ROM, ZIP disk or a CLICK disk.

27. Computer-readable memory medium according to claim 19, wherein revenue is generated from purchase of the hardcopy output.

28. Computer-readable memory medium according to claim 19, wherein the output is a display.

29. Computer-readable memory medium according to claim 19, wherein the display includes a display of the image data and the advertising information.

30. Computer-readable memory medium according to claim 19, wherein the display includes a display of the image data.

31. Computer-readable memory medium according to claim 30, wherein the displayed image data is a thumbnail image of the image data.

32. Computer-readable memory medium according to claim 19, wherein the output request is generated through a cable television system.

33. An apparatus for providing digital image services and generating revenue therefrom, comprising:
a program memory for storing process steps executable to perform the steps of (1) receiving, at a first location, image data retrieved from removable storage media and storing the image data at the first location, (2) receiving and storing advertising information at the first location, at least some portion of the advertising information is unique to the first location, and (3) responsive to an output request, generating output of the image data, the output including the advertising information, wherein revenue is generated from the use of the advertising information, and
a processor for executing the process steps stored in said program memory.

34. An apparatus according to claim 33, wherein the process steps further comprising the step of:
responsive to a request at the first location, uploading the image data from the first location to a second, remote location.

35. An apparatus according to claim 33, wherein the output is hardcopy output.

36. An apparatus according to claim 35, wherein other revenue is generated from purchase of the hardcopy output.

37. An apparatus according to claim 35, wherein the hardcopy output is a postcard.

38. An apparatus according to claim 35, wherein the hardcopy output is a photograph.

39. An apparatus according to claim 33, wherein the output is saved to removable storage medium.

40. An apparatus according to claim 39, wherein the removable storage medium is a CD-ROM, DVD-ROM, ZIP disk or a CLICK disk.

41. An apparatus according to claim 33, wherein revenue is generated from purchase of the hardcopy output.

42. An apparatus according to claim 33, wherein the output is a display.

43. An apparatus according to claim 33, wherein the display includes a display of the image data and the advertising information.

44. An apparatus according to claim 33, wherein the display includes a display of the image data.

45. An apparatus according to claim 44, wherein the displayed image data is a thumbnail image of the image data.

46. An apparatus according to claim 33, wherein the output request is generated through a cable television system.
